(19) United States
(12) Patent Application Publication
(10) Pub. No.: US 2014/0240228 A1
(43) Pub. Date: Aug. 28, 2014

(54) USER INTERFACE DISPLAY DEVICE

(71) Applicant: Noriyuki Juni, Ibaraki-shi (JP)

(72) Inventor: Noriyuki Juni, Ibaraki-shi (JP)

(73) Assignee: NITTO DENKO CORPORATION, Ibaraki-shi, Osaka (JP)

(21) Appl. No.: 14/343,021

(22) PCT Filed: Aug. 24, 2012
(86) PCT No.: PCT/JP2012/071455

§ 371 Date: Mar. 5, 2014

(30) Foreign Application Priority Data
Sep. 7, 2011 (JP) 2011-194937

(51) Int. Cl. G06F 3/03; G06F 3/01; G06K 9/00

(52) U.S. Cl. CPC G06F 3/0304; G06K 9/00355; G06F 3/017
USPC 345/156

(57) ABSTRACT

An optical panel having an image-forming function is disposed in parallel with a virtual horizontal plane so that the optical axis thereof is orthogonal to the virtual horizontal plane. A flat panel display is disposed in offset relation below the optical panel such that a display surface of the flat panel display is inclined at a predetermined angle with respect to the virtual horizontal plane and faces upward. A light source for projecting light toward a hand, and a camera for imaging the reflection of the light from the hand are provided below or above a spatial image image-formed above the optical panel. This provides a user interface display device which does not include structure serving as an obstacle to manipulation around the spatial image projected in space to achieve an interaction with the spatial image by using the hand of the operator in a natural manner.

### TECHNICAL FIELD

The present invention relates to a user interface display device which changes a spatial image in bidirectional relation to the motion of a hand (interactively) by moving the hand disposed around the spatial image.

### BACKGROUND ART

Known schemes for displaying video pictures in space include a two-eye scheme, a multi-eye scheme, a spatial image scheme, a volume display scheme, a hologram scheme and the like. In recent years, there has been proposed a display device for displaying video pictures which allows a user to intuitively manipulate a two-dimensional video picture or a three-dimensional video picture (a spatial image) displayed in space with his or her hand, finger and the like, thereby achieving an interaction with the spatial image.

As a recognition input means (user interface) for a hand, finger and the like in such a display device, there has been proposed a system which forms a lattice of vertical and horizontal light beams in a sensing region (plane) by using a multiplicity of LEDs, lamps and the like to sense an input body that intercepts the lattice of light beams by means of a light receiving element and the like, thereby detecting the position or coordinates of the input body (hand) (with reference to Patent Literatures 1 and 2, for example).

### CITATION LIST

### Patent Literature

PTL 1: Japanese Published Patent Application No. 2005-141102
PTL 2: Japanese Published Patent Application No. 2007-156370

### SUMMARY OF INVENTION

However, the display device having the user interface which senses the interception of the lattice of light beams formed in the sensing region (plane) to detect the position or coordinates of the input body as described above has a frame used for installation of the aforementioned LEDs and the light receiving element. This frame is always disposed in a near position (closer to an operator) relative to the spatial image to come into the field of view of the operator. This makes the operator conscious of the frame as an obstacle, resulting in unnatural or unsmooth motion of the hand of the operator in some cases.

In view of the foregoing, it is therefore an object of the present invention to provide a user interface display device which does not include any structure serving as an obstacle to manipulation around a spatial image projected in space to achieve an interaction with the spatial image by using a hand of an operator in a natural manner.

To accomplish the aforementioned object, a user interface display device according to the present invention is a user interface display device for causing a video picture appearing on a display surface of a flat panel display to be image-formed in a spatial position spaced a predetermined distance apart therefrom by means of an optical panel having an image-forming function, thereby interactively controlling the video picture on the flat panel display in association with the motion of a hand positioned around this spatial image, wherein the optical panel is disposed in parallel with a virtual horizontal plane based on an operator so that the optical axis of the optical panel is orthogonal to the virtual horizontal plane, wherein the flat panel display is disposed in offset relation below the optical panel in such an attitude that the display surface is inclined at a predetermined angle with respect to the virtual horizontal plane and is positioned to face upward, and wherein a light source for projecting light toward the hand and one optical imaging means for imaging the reflection of the light from the hand are provided in a pair below or above the spatial image image-formed above the optical panel.

The present inventor has diligently made studies to solve the aforementioned problem, and has hit upon the idea of shooting a hand with a small number of cameras distant from a spatial image for the purpose of reducing psychological burdens on an operator during an input operation using the hand. The present inventor has focused attention on the motion (image) of the hand during the shooting with the cameras, and has made further studies. As a result, the present inventor has found that the motion of the hand serving as an input body is sufficiently detected with a simple configuration having a single camera by placing a display and an optical panel for image-forming the display on the display in a predetermined positional relationship to project the display (spatial image) appearing on the display in space above the aforementioned optical panel and by shooting the hand inserted around the aforementioned spatial image with an optical imaging means such as a camera disposed below or above the spatial image to identify the position or coordinates of the aforementioned hand based on this image. Hence, the present inventor has attained the present invention.

The present invention has been made based on the aforementioned findings. The user interface display device according to the present invention includes a flat panel display for displaying a video picture, and an optical panel such as a lens for projecting a video picture in space. The aforementioned optical panel is disposed in parallel with a virtual horizontal plane based on an operator so that the optical axis of the optical panel is orthogonal to the virtual horizontal plane. The aforementioned flat panel display is disposed below the aforementioned optical panel in such an attitude that the display surface thereof is inclined and is positioned to face upward. A light source and one optical imaging means are provided in a pair below or above the aforementioned optical panel. Thus, the user interface display device according to the present invention is a user-friendly display device which allows the operator to perform an interaction with the aforementioned spatial image by using the hand in a natural manner without being conscious of the system which detects the position or coordinates of the input body.

Further, the user interface display device according to the present invention, in which the single optical imaging means is sufficient, is advantageous in that the user interface display device for detecting the motion of the hand is provided with simple facilities at low costs. Further, the flexibility of the placement of the aforementioned optical imaging means (camera or the like) is improved, so that the camera or the like may be provided (hidden) in a position of which an operator is unconscious.

In particular, in the user interface display device according to the present invention wherein the light source and the optical imaging means are disposed in adjacent relation around the optical panel and wherein this optical imaging means images the reflection of light from the hand positioned above the optical panel, the aforementioned optical parts may be unitized together. This improves the flexibility of the placement of the aforementioned optical parts, and makes the user interface display device more simplified in configuration and lower in costs.

In particular, the user interface display device according to the present invention preferably comprises: a control means for controlling the light source, the optical imaging means and the flat panel display; a shape recognition means for acquiring the reflection of light projected from the light source toward the hand as a two-dimensional image to binarize the two-dimensional image by computation, thereby recognizing the shape of the hand; and a display updating means for comparing the positions of the hand before and after a predetermined time interval to update the video picture on the flat panel display to a video picture corresponding to the motion of the hand, based on the motion of the hand. Thus, the user interface display device according to the pre sent invention uses only the one optical imaging means to be able to detect the motion of a human hand with high sensitivity from the image analysis of the one optical imaging means. Also, an interaction between the spatial image and the hand of the operator is achieved by updating (changing) a video picture on the aforementioned flat panel display to a video picture corresponding to the motion of the aforementioned hand, based on the aforementioned detection.

### BRIEF DESCRIPTION OF DRAWINGS

FIG. 1 is a view schematically illustrating a configuration of a user interface display device according to the present invention.

FIGS. 2A and 2B are views showing a configuration of the user interface display device according to a first embodiment of the present invention.

FIGS. 3A to 3C are views illustrating a method for detecting the coordinates (X and Y directions) of a hand in the user interface display device according to the first embodiment.

FIG. 4 is a view showing an example of the motion of the hand in the user interface display device according to the first embodiment.

FIGS. 5A and 5B are views showing a method for detecting the motion of the hand in the user interface display device according to the first embodiment.

FIG. 6 is a view showing a configuration of the user interface display device according to a second embodiment of the present invention.

FIG. 7 is a view illustrating a method for projecting a spatial image in the user interface display device according to the second embodiment.

FIG. 8 is a view illustrating a structure of an image-forming optical element used for an optical panel in the user interface display device according to the second embodiment.

FIG. 9 is a sectional view illustrating a detailed structure of the image-forming optical element used for the aforementioned optical panel.

FIG. 10 is a view showing another configuration of the user interface display device according to the second embodiment.

FIG. 11 is a view showing still another configuration of the user interface display device according to the second embodiment.

FIG. 12 is a view showing a configuration of the user interface display device according to a third embodiment of the present invention.

FIG. 13 is a view illustrating a first structure of the image-forming optical element used for the optical panel in the user interface display device according to the third embodiment.

FIG. 14 is an exploded perspective view illustrating a configuration of the aforementioned image-forming optical element.

FIG. 15 is a view illustrating a second structure of the image-forming optical element used for the optical panel in the user interface display device according to the third embodiment.

FIG. 16 is an exploded perspective view illustrating a configuration of the image-forming optical element having the aforementioned second structure.

FIG. 17 is a view illustrating a third structure of the image-forming optical element used for the optical panel in the user interface display device according to the third embodiment.

FIG. 18 is an exploded perspective view illustrating a configuration of the image-forming optical element having the aforementioned third structure.

FIG. 19 is a view illustrating a configuration of the image-forming optical element having a fourth structure and used for the optical panel in the user interface display device according to the third embodiment.

### DESCRIPTION OF EMBODIMENTS

Next, embodiments according to the present invention will now be described in detail with reference to the drawings. It should be noted that the present invention is not limited to the embodiments.

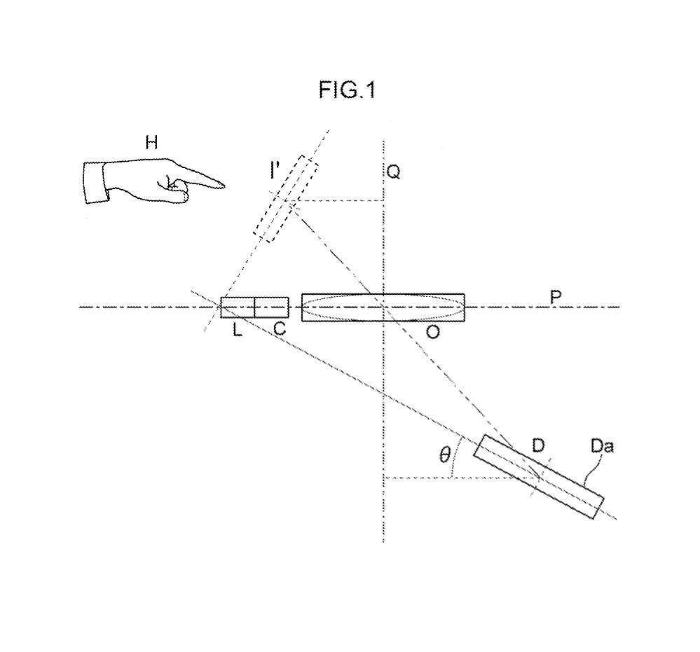

FIG. 1 is a view illustrating a configuration of a user interface display device according to the present invention in principle.

The user interface display device according to the present invention projects and displays a video picture appearing on a flat panel display D as a two-dimensional spatial image I′ before the eyes of an operator (not shown) positioned behind a hand H. The user interface display device according to the present invention includes an optical panel O disposed in parallel with a virtual horizontal plane P based on (the sensibility of) the aforementioned operator, and the flat panel display D disposed below a position distant from this optical panel O and having a display surface Da inclined at a predetermined angle θ and positioned to face upward. The aforementioned user interface display device further includes at least one light source L for projecting light toward the aforementioned hand H, and an optical imaging means (camera C) for imaging reflected light from the hand H. The at least one light source L and the optical imaging means (camera C) are disposed in a pair below the spatial image I′ projected by the aforementioned optical panel O. This is a characteristic of the user interface display device according to the present invention.

The configuration of the aforementioned user interface display device will be described in further detail. An optical part (image-forming optical element) capable of optically image-forming an image such as a lens including a Fresnel lens, a lenticular lens, a fly-eye lens and the like, a lens array, a mirror, a micromirror array, and a prism are used for the aforementioned optical panel O. Of these components, a micromirror array capable of forming a sharp spatial image I′ is preferably employed in the present embodiment. It should be noted that this optical panel O is disposed so that an optical axis Q thereof is orthogonal to the virtual horizontal plane P based on the operator, i.e. so that the front surface or the back surface of the panel O is parallel with the aforementioned virtual horizontal plane P.

A flat-shaped, self light emitting display such as a liquid crystal display (LCD), an organic EL display and a plasma display (PDP) is preferably employed as the aforementioned flat panel display D. This flat panel display D is disposed below a position distant from the optical panel O in such an attitude that the display surface Da thereof is inclined at the predetermined angle θ with respect to the aforementioned virtual horizontal plane P and is positioned to face upward. The angle θ of the aforementioned flat panel display D with respect to the virtual horizontal plane P is set at 10 to 85 degrees. A display which produces colors using reflected light by means of an external light source, and a cathode ray tube display may be also used as the aforementioned flat panel display D.

The single camera C described above includes a CMOS or CCD image sensor, and is disposed below the aforementioned spatial image I′, with its shooting direction oriented upward. The light source L is disposed on the same side of (in this example, below) the aforementioned spatial image I′ as the aforementioned camera C. Examples of the light source L used herein include an illuminator or a lamp which emits light having a range other than that of visible light (e.g., infrared light having a wavelength on the order of 700 to 1000 nm) so as not to hinder the field of vision of an operator who performs an input operation, such as an LED and a semiconductor laser (VCSEL). The aforementioned camera C and the light source L may be disposed in a pair (as a set) above the spatial image I′ (hand H). Examples of the optical imaging means for use in the user interface display device according to the present invention include various optical sensors including a photoelectric conversion element such as a photodiode, a phototransistor, a photo IC, a photo reflector and CdS, in addition to the camera C including the aforementioned CMOS image sensor or the CCD image sensor.

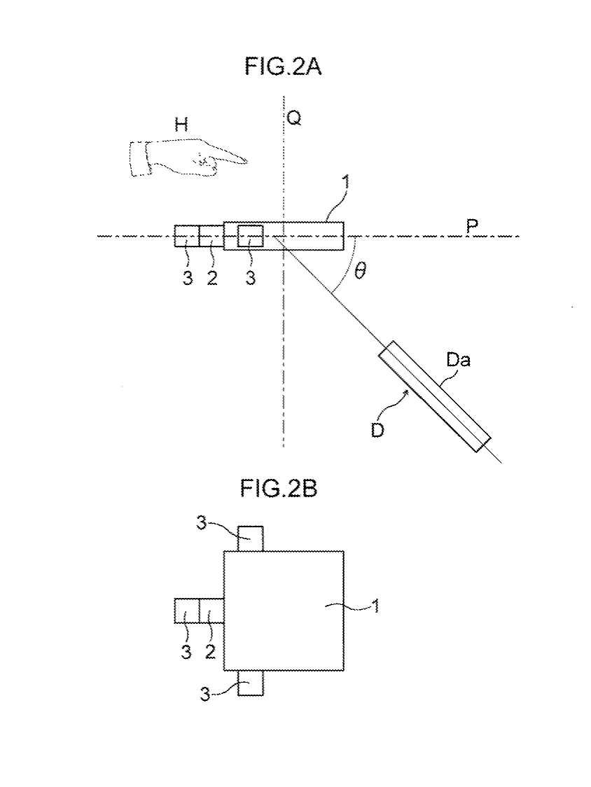

Next, a more specific embodiment of the user interface display device according to the present invention will be described. FIG. 2A is a schematic view showing a configuration of the user interface display device according to a first embodiment. FIG. 2B is a plan view around an optical panel 1 of this user interface display device.

In the user interface display device according to this embodiment, two plano-convex Fresnel lenses (an outside shape of 170 mm square, and a focal length of 305 mm) laid one on top of the other are used as the optical panel 1. A ¼-inch CMOS camera (NCM03-S manufactured by Asahi Electronics Laboratory Co., Ltd.) is used as a camera 2. Infrared LEDs (having a wavelength of 850 nm, and an output of 8 mW; LED851W manufactured by Thorlabs, Inc.) are used as light sources 3. A liquid crystal display (a 12-inch TFT display manufactured by Panasonic Corporation) is used as the flat panel display D.

Although not shown, a computer is provided in the aforementioned user interface display device. The computer has the functions of: a control means for controlling the aforementioned light sources 3, the camera 2 and the flat panel display D; a shape recognition means for acquiring the reflection of light projected from the aforementioned light sources 3 toward the hand H as a two-dimensional image (H′) to binarize this two-dimensional image by computation (H″), thereby recognizing the shape of the hand H; and a display updating means for comparing the positions of the aforementioned hand H before and after a predetermined time interval to update a video picture appearing on the aforementioned flat panel display D to a video picture corresponding to the motion of the aforementioned hand H, based on the motion of the hand H. The angle (angle of the display surface Da) θ of the aforementioned flat panel display D with respect to the optical panel 1 (virtual horizontal plane P) is set at 45 degrees in this example.

Next, a method for specifying the position of the hand H inserted around the spatial image I′ (into a sensing region) of the aforementioned user interface display device and for detecting the motion of the hand H will be described in a step-by-step manner.

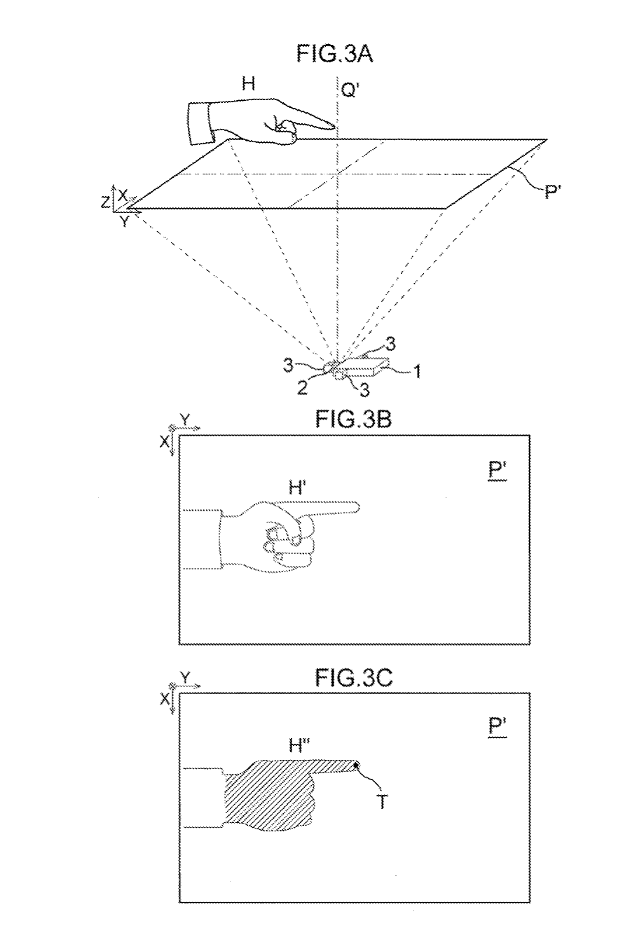

For the specification of the position (coordinates) of the aforementioned hand H, light is initially projected from the light sources 3 disposed below the hand H toward the hand H, as shown in FIG. 3A. This projection of light may be intermittent light emission [light projecting step]. Next, with light projected, this hand H is shot with the camera 2 disposed on the same side of (in this example, below) the aforementioned hand H as the light sources 3, and the reflection of the aforementioned light (reflected light or reflected image) from the hand H is acquired as the two-dimensional image H′ (an image on a virtual imaging plane P′ parallel with the aforementioned virtual horizontal plane P) having coordinate axes extending in X and Y directions orthogonal to each other, as shown in FIG. 3B [imaging step].

Next, the aforementioned acquired two-dimensional image H′ is binarized, based on a threshold value. Thereafter, as shown in FIG. 3C, the outside shape (shaded with diagonal lines in the figure) of the aforementioned hand H is recognized in the resultant binary image H″. Thereafter, a finger protruding from a fist, for example, is identified. The coordinates (fingertip coordinates T) corresponding to the tip position of the finger are calculated by computation. Then, the fingertip coordinates T are stored in a storage means of the control means (computer) and the like [coordinate specifying step].

The process of detecting the motion of the aforementioned hand H employs the aforementioned specified fingertip coordinates T. In the method therefor, the step [light projecting step] of projecting the aforementioned light, the step [imaging step] of acquiring the two-dimensional image and the step [coordinate specifying step] of calculating the fingertip coordinates T are initially repeated at determined time intervals. The fingertip coordinates T after the repetition are measured again [measuring step].

The distance and direction of the movement of the aforementioned fingertip coordinates T are calculated using the values of the fingertip coordinates T(Xm,Yn) before and after the lapse of the aforementioned repetition. Based on the result of calculation, a video picture on the flat panel display D, i.e. the spatial image I′, is updated to a video picture corresponding to the motion of the aforementioned hand H [display updating step].

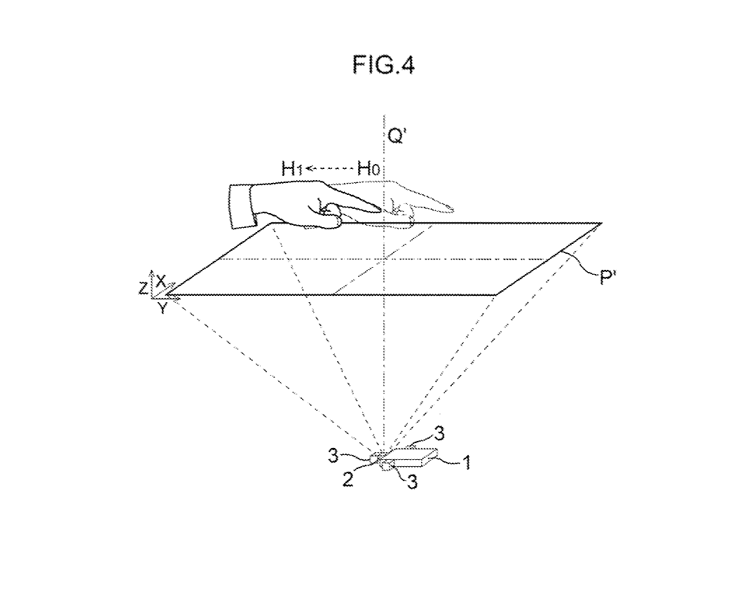

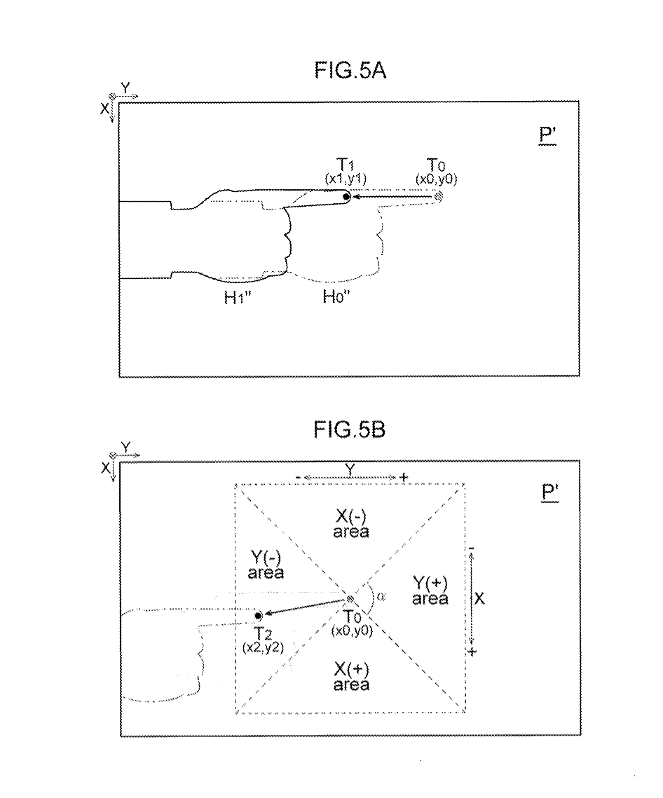

For example, when the hand (input body) makes a horizontally sliding movement (H₀→H₁) as shown in FIG. 4, the aforementioned fingertip coordinates T move as represented by binary images (H₀″→H₁″) of FIG. 5A. Specifically, the aforementioned fingertip coordinates T move from an initial position (coordinates T₀) before the movement to a position (coordinates T₁) after the movement which is indicated by solid lines. At this time, the distance and direction of the movement of the aforementioned fingertip are calculated by the repetition of the aforementioned measuring step using the values of coordinates (X₀,Y₀) and coordinates (X₁,Y₁) before and after the repetition.

For the detection of the motion of the aforementioned hand H, an identification region in which the motion (T₀→T₂) of the aforementioned fingertip coordinates T is allocated on an area-by-area basis to four directions [X(+), X(−), Y(+) and Y(−)] may be defined on the virtual imaging plane P′ having the coordinate axes extending in the X and Y directions, as shown in FIG. 5B. With such a configuration, the aforementioned hand H is treated as a pointing device which outputs signals of the four directions (positive and negative directions of X and Y) resulting from the movement of the fingertip coordinates T in a simplified manner, such as a mouse device and a tablet device in a computer and the like. In other words, the display on the aforementioned flat panel display D is updated in real time in corresponding relation to the motion of the aforementioned hand H at the same time as the detection of the motion of the hand H in the aforementioned determining step. It should be noted that the setting angle α, shape, arrangement and the like of the areas in the aforementioned identification region may be set in accordance with devices that output the aforementioned signals, applications and the like.

As described above, the user interface display device according to the first embodiment of the present invention with a simple and less costly configuration is capable of specifying the position or coordinates of the hand H. In addition, this user interface display device does not have any structure serving as an obstacle to manipulation around the spatial image I′ projected in space to achieve an interaction with the spatial image I′ by using the hand H of an operator in a natural manner.

Next, the user interface display device according to a second embodiment of the present invention will be described.

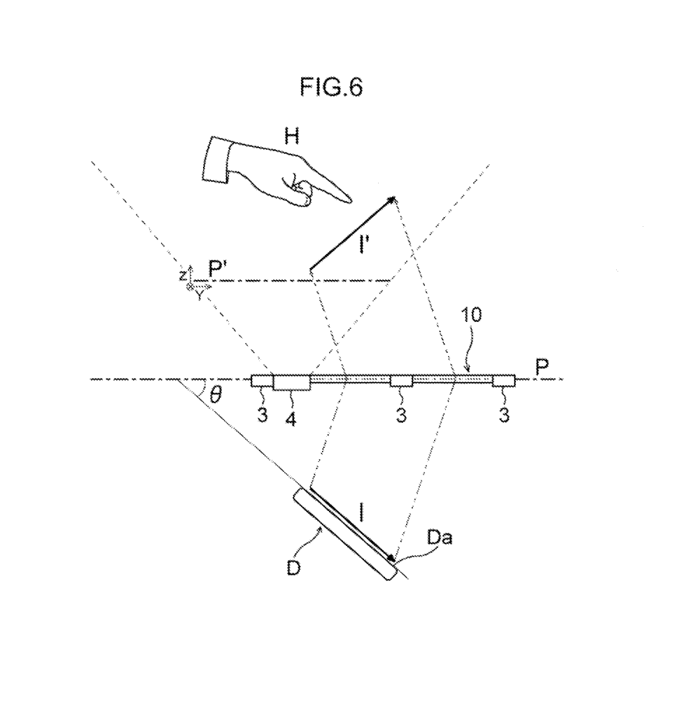

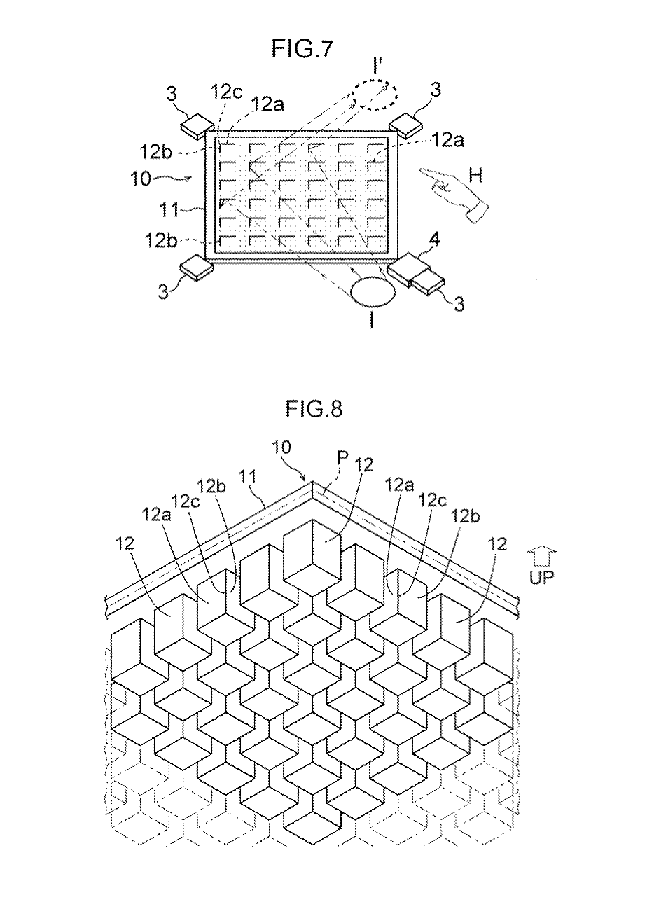

FIGS. 6, 10 and 11 are views showing configurations of the user interface display device according to the second embodiment of the present invention. FIG. 7 is a view illustrating a method for projecting the spatial image I′ in this user interface display device. In the figures, a plane P indicated by a dash-dot line is a “virtual horizontal plane” (“element plane” in an optical element) based on the sensibility of an operator, as in the aforementioned first embodiment, and planes P′ and P″ indicated by dash-dot lines are “virtual imaging planes” corresponding to the virtual imaging plane P′ (with reference to FIGS. 3 to 5) formed by the camera 2 of the first embodiment.

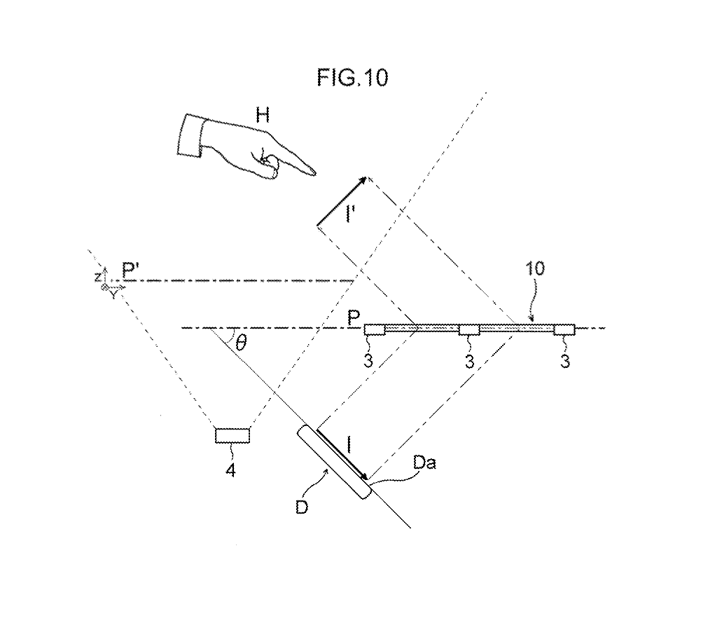

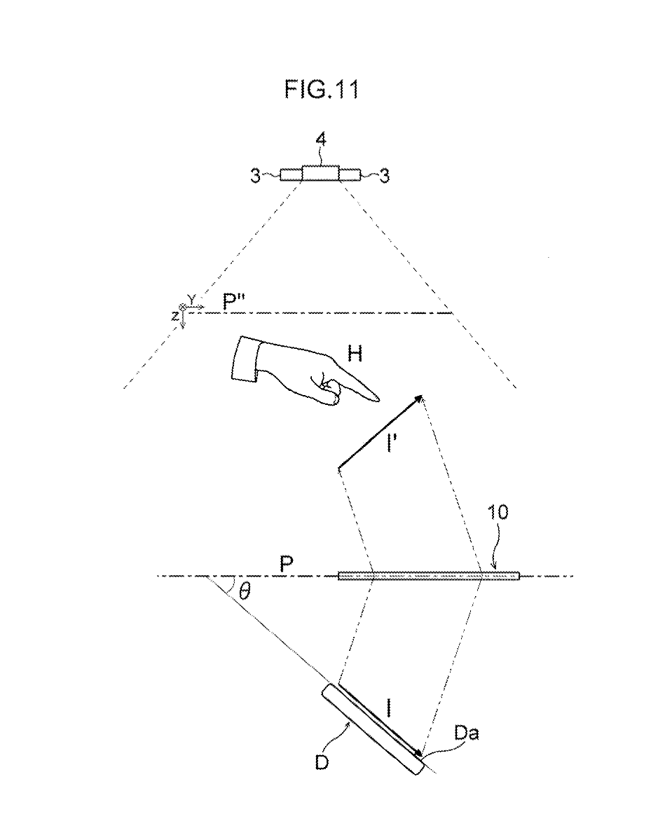

The user interface display device according to the present embodiment uses an optical panel (micromirror array 10) having an image-forming function to cause a video picture (image I) appearing on the display surface Da of the flat panel display D to be image-formed (spatial image I′) in a spatial position above the panel. The aforementioned flat panel display D is disposed in offset relation below the aforementioned micromirror array 10 in such an attitude that the display surface Da thereof is inclined at the predetermined angle θ with respect to the virtual horizontal plane P based on the operator and is positioned to face upward. The light sources 3 for projecting light toward the hand H of the operator and the optical imaging means (PSD designated by the reference numeral 4) for imaging the reflection of light from the hand H are disposed in a pair below (FIGS. 6 and 10) or above (FIG. 11) the spatial image I′ projected by the aforementioned micromirror array 10.

The configuration of the user interface display device according to the aforementioned second embodiment differs from that of the user interface display device according to the first embodiment in that the micromirror array 10 having a multiplicity of protruding corner reflectors (unit optical elements) is used as the image-forming optical element capable of optically image-forming an image, and in that the PSD (Position Sensitive Detector) is used as the optical imaging means for imaging the reflection of light from the hand H.

The aforementioned micromirror array (protruding corner reflector array) 10 will be described in detail. As shown in FIG. 8, this micromirror array 10 includes a multiplicity of downwardly protruding minute unit optical elements 12 (corner reflectors) in the shape of quadrangular prisms which are provided on the lower surface (the lower surface side of the optical panel in FIGS. 6 and 7) of a substrate (base) 11 and arranged in a diagonal checkerboard pattern [FIG. 8 is a view of the array as seen in an upward direction from below.].

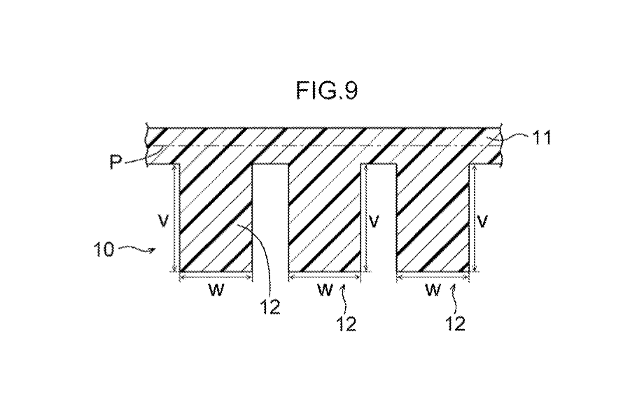

As shown in cross section in FIG. 9, each of the unit optical elements 12 in the shape of quadrangular prisms in the aforementioned micromirror array 10 has a pair of (two) light reflecting surfaces (a first side surface 12a and a second side surface 12b on the lateral sides of the quadrangular prism) constituting a corner reflector. Each of the light reflecting surfaces is of a rectangular shape having the “ratio of the length (height v) as measured in the direction of the thickness of the substrate to the width (width w) as measured in the direction of the surface of the substrate” [aspect ratio (v/w)] of not less than 1.5.

The pair of light reflecting surfaces (first side surface 12a and the second side surface 12b) which form an edge 12c of each of the unit optical elements 12 are designed to face toward the eyepoint of the operator (toward the base of the hand H as seen in FIGS. 6 and 7). When this micromirror array 10 and its surroundings are viewed from above, the aforementioned array 10 is disposed, with the outer edges thereof rotated 45 degrees with respect to the front of the operator (the direction of the hand H), as shown in FIG. 7. The image I below the micromirror array 10 is projected onto a symmetrical position (above the optical panel) with respect to the array 10, so that the spatial image I′ is image-formed. In FIG. 7, the reference numeral 3 designates light sources disposed around the aforementioned micromirror array 10 to illuminate the hand H.

As shown in FIG. 7, the PSD (reference numeral 4) for detecting the aforementioned hand H is provided in a near position (closer to an operator) relative to the micromirror array 10 and below this hand H, and is disposed to be able to detect the reflection of infrared light and the like projected from the aforementioned light sources 3. This PSD (4) recognizes light reflection (reflected light or reflected image) from the hand H to output the distance to this hand H as a position signal, and is capable of measuring the distance to the input body with high accuracy by previously acquiring a correlation (reference) between the distance and the position signal (voltage). When a two-dimensional PSD is used as the aforementioned PSD (4), this two-dimensional PSD may be disposed as it is in place of the aforementioned camera 2. When one-dimensional PSDs are used, two or more one-dimensional PSDs may be dispersedly disposed in a plurality of positions where the coordinates of the aforementioned hand H can be measured by triangulation. The use of these PSDs (or a unitized PSD module) improves the position detection accuracy of the hand H.

The light sources 3 and the PSD (4) are provided in positions which are below the spatial image I′ and around the micromirror array 10 in the examples of FIGS. 6 and 7. However, the positions of the light sources 3 and the PSD (4) are not particularly limited. For example, as shown in FIG. 10, the PSD (4) for recognizing light reflection from the hand H may be disposed in a position distant from and below the micromirror array 10 (in this example, a position under the hand H). Also, as shown in FIG. 11, the aforementioned light sources 3 and the PSD (4) may be disposed above the spatial image I′ and the hand H. In either case, the aforementioned light sources 3 and the PSD (4) are disposed in a positional relationship such that the PSD (4) is able to receive the light projected from the light sources 3 and reflected from the hand H without entering an area shadowed by the micromirror array 10 (a blind spot).

A flat-shaped, self light emitting display such as a liquid crystal display (LCD), an organic EL display and a plasma display (PDP) is preferably employed as the aforementioned flat panel display D, as in the first embodiment. The flat panel display D is disposed below the micromirror array 10 in such an attitude that the display surface Da thereof is inclined at the predetermined angle θ (in this example, 10 to 85 degrees) with respect to the aforementioned virtual horizontal plane P and is positioned to face upward.

Examples of the light sources 3 used herein include illuminators or lamps which emit light having a range other than that of visible light (e.g., infrared light having a wavelength on the order of 700 to 1000 nm) so as not to hinder the field of vision of an operator who performs an input operation, such as LEDs and semiconductor lasers (VCSELs).

The method for specifying the position of the hand H inserted around the spatial image I′ (into the sensing region) and for detecting the motion of the hand H in the user interface display device having the aforementioned configuration according to the second embodiment is performed by steps similar to those of the first embodiment (with reference to FIGS. 3 to 5 and the aforementioned light projecting step, imaging step, coordinate specifying step, measuring step and display updating step). When the aforementioned PSD (4) is used, the aforementioned imaging step and coordinate specifying step are performed throughout in the form of the internal process of the PSD (4), and only the resultant coordinates are outputted.

The user interface display device according to the aforementioned second embodiment with a simple and less costly configuration is capable of specifying the position or coordinates of the hand H. In addition, this user interface display device does not have any structure serving as an obstacle to manipulation around the spatial image I′ projected in space to achieve an interaction with the spatial image I′ by using the hand H of an operator in a natural manner.

Next, the user interface display device according to a third embodiment of the present invention will be described.

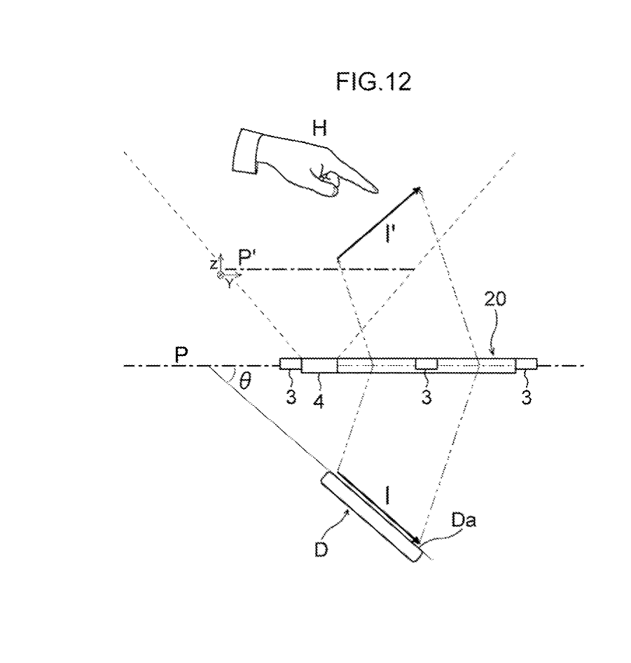

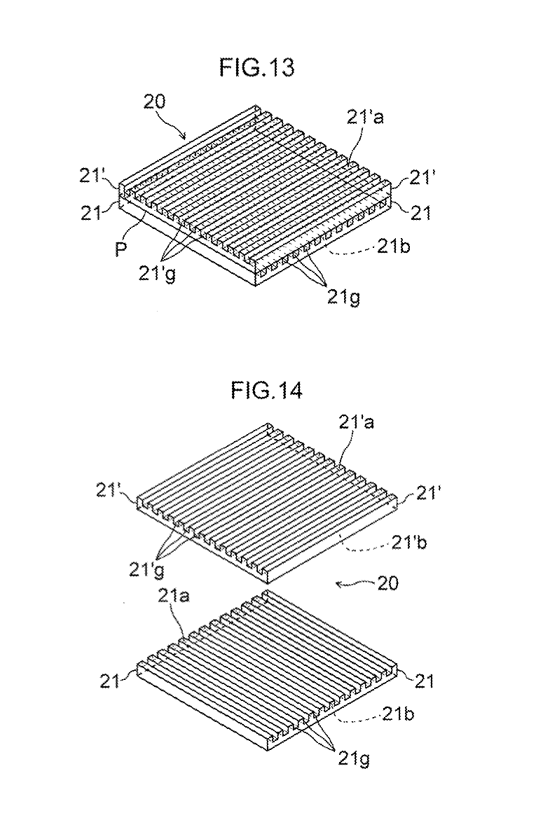

FIG. 12 is a view showing a configuration of the user interface display device according to the third embodiment of the present invention. FIGS. 13, 15, 17 and 19 are perspective views of micromirror arrays (20, 30, 40 and 50) used in this user interface display device. In the figures, a plane P indicated by a dash-dot line is a “virtual horizontal plane” (“element plane” in an optical element) based on the sensibility of an operator, as in the first and second embodiments, and a plane P′ indicated by a dash-dot line is a “virtual imaging plane” corresponding to the virtual imaging plane P′ (with reference to FIGS. 3 to 5) formed by the camera 2 of the first embodiment and the PSD (4) of the second embodiment.

The user interface display device according to the present embodiment uses an optical panel (micromirror arrays 20, 30, 40 and 50) having an image-forming function to cause a video picture (image I) appearing on the display surface Da of the flat panel display D to be image-formed (spatial image I′) in a spatial position above the panel. The aforementioned flat panel display D is disposed in offset relation below the micromirror array 20 (30, 40 and 50) in such an attitude that the display surface Da thereof is inclined at the predetermined angle θ with respect to the virtual horizontal plane P based on the operator and is positioned to face upward. The light sources 3 for projecting light toward the hand H of the operator and the optical imaging means (PSD designated by the reference numeral 4) for imaging the reflection of light from the hand H are disposed in a pair below (FIG. 12) or above (not shown) the spatial image I′ projected by the aforementioned micromirror array 20 (30, 40 and 50).

The configuration of the user interface display device according to the aforementioned third embodiment differs from that of the user interface display device according to the aforementioned second embodiment in that one of the micromirror arrays 20, 30, 40 and 50 including one or two optical elements obtained by forming a plurality of parallel linear grooves spaced at predetermined intervals by dicing using a rotary blade on a surface of a flat-shaped transparent substrate is used as the image-forming optical element (optical panel) capable of optically image-forming an image.

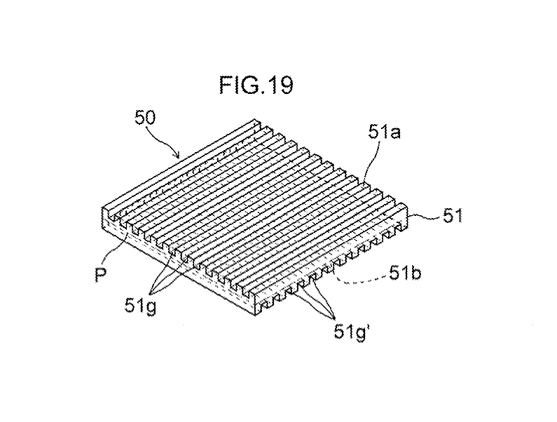

In these micromirror arrays 20, 30, 40 and 50, the two optical elements (substrates) having the plurality of parallel grooves formed on the front surfaces thereof are laid one on top of the other, with one of the optical elements rotated 90 degrees (FIGS. 14, 16 and 18), or the one flat-shaped substrate has the plurality of parallel grooves formed on the front and back surfaces thereof so as to be orthogonal to each other as seen in plan view (FIG. 19). As a result, as seen in the direction of the front and back surfaces of the substrate(s) (in a vertical direction), corner reflectors are formed respectively at the intersections (points of intersection of a lattice) of a first group of parallel grooves and a second group of parallel grooves which are orthogonal to each other as seen in plan view. The corner reflectors are comprised of light-reflective vertical surfaces (wall surfaces) of the first group of parallel grooves, and light-reflective vertical surfaces (wall surfaces) of the second group of parallel grooves.

The light-reflective wall surfaces of the first group of parallel grooves of the substrate and the light-reflective wall surfaces of the second group of parallel grooves of the substrate which constitute the aforementioned corner reflectors are what is called in “skew” relation as seen three-dimensionally. It is also advantageous that the adjustment of the optical performance of the optical elements, such as an increase in aspect ratio [height (length as measured in the direction of the thickness of the substrate)/width (width as measured in a horizontal direction of the substrate)] of the light reflecting surfaces of the aforementioned corner reflectors, is made relatively easily because the aforementioned parallel grooves and the light-reflective wall surfaces thereof are formed by dicing using a rotary blade.

The structures of the aforementioned respective micromirror arrays will be described individually in further detail. Optical elements (21 and 21′) constituting the micromirror array 20 shown in FIGS. 13 and 14 are configured such that a plurality of parallel linear grooves 21g and grooves 21′g spaced at predetermined intervals are formed by dicing using a rotary blade in upper surfaces 21a and 21′a of flat-shaped transparent substrates 21 and 21′ respectively. The aforementioned micromirror array 20 (FIG. 13) is formed using the two optical elements (substrates 21 and 21′) identical in shape. With the first upper substrate 21′ rotated relative to the second lower substrate 21 so that the continuous directions of the grooves 21g and the grooves 21′g provided in the substrates 21 and 21′ are orthogonal to each other as seen in plan view, the back surface 21′b (where the grooves 21′g are not formed) of the upper substrate 21′ is brought into abutment with the front surface 21a of the lower substrate 21 where the grooves 21g are formed. These substrates 21 and 21′ are vertically laid one on top of the other and fixed together to constitute the single array 20.

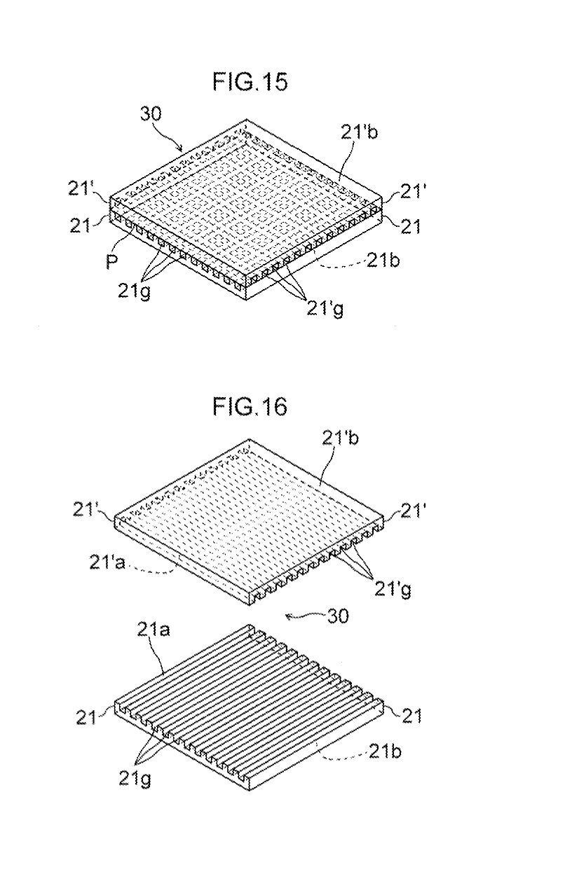

Similarly, the micromirror array 30 shown in FIG. 15 is formed using two optical elements (substrates 21 and 21′) identical in shape and manufacturing method with those described above. As shown in FIG. 16, with the first upper substrate 21′ flipped upside down and rotated 90 degrees relative to the second lower substrate 21, the front surface 21′a of the upper substrate 21′ where the grooves 21′g are formed is brought into abutment with the front surface 21a of the lower substrate 21 where the grooves 21g are formed. These substrates 21 and 21′ are vertically laid one on top of the other and fixed together to constitute the single array 30 in which the continuous directions of the grooves 21g and the grooves 21′ g provided in the substrates 21 and 21′ are orthogonal to each other as seen in plan view.

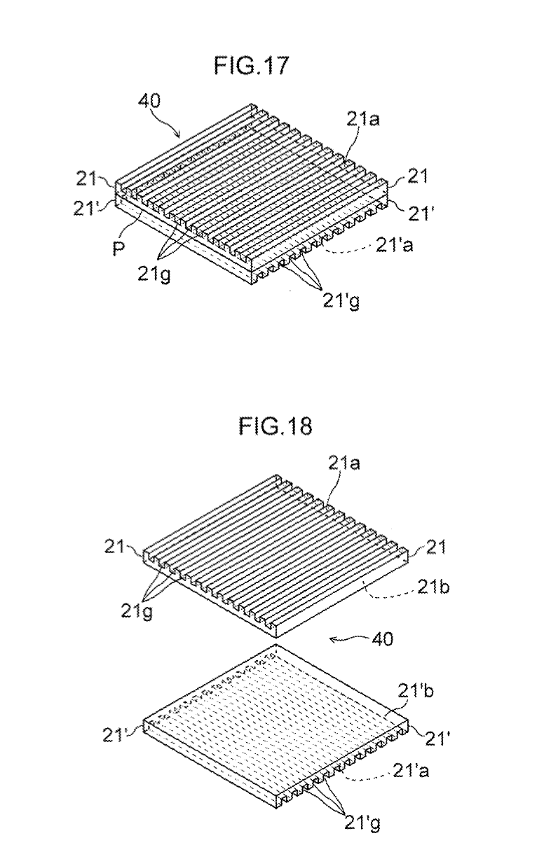

Further, the micromirror array 40 shown in FIG. 17 is formed using two optical elements (substrates 21 and 21′) identical in shape and manufacturing method with those described above. As shown in FIG. 18, with the first lower substrate 21′ flipped upside down and rotated 90 degrees relative to the second upper substrate 21, the back surface 21b of the upper substrate 21 and the back surface 21′ b of the lower substrate 21′ are brought into abutment with each other. These substrates 21 and 21′ are vertically laid one on top of the other and fixed together to constitute the single array 40 in which the continuous directions of the grooves 21g and the grooves 21′ g provided in the substrates 21 and 21′ are orthogonal to each other as seen in plan view.

The micromirror array 50 shown in FIG. 19 is configured such that a plurality of parallel linear grooves 51g and grooves 51′g spaced at predetermined intervals are formed by dicing using a rotary blade in an upper front surface 51a and a lower back surface 51b, respectively, of a flat-shaped transparent substrate 51. The formation directions (continuous directions) of the grooves 51g in the front surface 51a and the grooves 51′g in the back surface 51b are orthogonal to each other as see in plan view.

The configurations and arrangement of the light sources 3, the PSD (4), the flat panel display D and the like applied in the user interface display device according to the third embodiment including the aforementioned micromirror arrays 20, 30, 40 and 50 are similar to those of the aforementioned second embodiment. The method for specifying the position of the hand H inserted around the spatial image I′ (into the sensing region) and for detecting the motion of the hand H in the third embodiment is performed by steps similar to those of the first embodiment (with reference to FIGS. 3 to 5).

The user interface display device according to the aforementioned third embodiment with a simple and less costly configuration is capable of specifying the position or coordinates of the hand H. In addition, this user interface display device does not have any structure serving as an obstacle to manipulation around the spatial image I′ projected in space to produce the effect of achieving an interaction with the spatial image I′ by using the hand H of an operator in a natural manner. Further, the user interface display device according to the aforementioned third embodiment is advantageous in that the costs of the entire device are reduced because the micromirror arrays (20, 30, 40 and 50) used therein are less costly.

Although specific forms in the present invention have been described in the aforementioned examples, the aforementioned examples should be considered as merely illustrative and not restrictive. It is contemplated that various modifications evident to those skilled in the art could be made without departing from the scope of the present invention.

The user interface display device according to the present invention is capable of remotely recognizing and detecting the position or coordinates of a human hand by means of the single optical imaging means. This allows an operator to intuitively manipulate a spatial image without being conscious of the presence of an input system.

### REFERENCE SIGNS LIST

C Camera
D Flat panel display
Da Display surface
H Hand
L Light source
O Optical panel
P Virtual horizontal plane
P′, P″ Virtual imaging planes
Q Optical axis
I Image
I′ Spatial image
T Fingertip coordinates
1 Optical panel
2 Camera
3 Light sources
4 PSD
10 Micromirror array
11 Substrate
12 Unit optical elements
12a, 12b Side surfaces
12c Edges
20, 30, 40 Micromirror arrays
21, 21′ Substrates
21a, 21′a Front surfaces
21b, 21′b Back surfaces
21g, 21′g Grooves
50 Micromirror array
51 Substrate
51a Front surface
51b Back surface
51g, 51g′ Grooves

What is claimed is:

1. A user interface display device for interactively controlling a video picture in association with the motion of a hand, comprising:
a flat panel display including a display surface;
an optical panel;
a light source for projecting light toward the hand; and
an optical imaging means for imaging the reflection of the light from the hand;
wherein a video picture appearing on the display surface of the flat panel display is image-formed in a spatial position spaced a predetermined distance apart from the flat panel display by means of the optical panel,
wherein the optical panel is disposed in parallel with a virtual horizontal plane based on an operator, so that the optical axis of the optical panel is orthogonal to the virtual horizontal plane,
wherein the flat panel display is disposed in an offset relation below the optical panel in such an attitude that the display surface is inclined at a predetermined angle with respect to the virtual horizontal plane and is positioned to face upward, and
wherein the light source and the optical imaging means are provided in a pair below or above the spatial position at which the video picture is image-formed above the optical panel.

2. The user interface display device according to claim 1,
wherein the light source and the optical imaging means are disposed in an adjacent relationship around the optical panel, and
wherein the optical imaging means images the reflection of light from the hand positioned above the optical panel.

3. The user interface display device according to claim 1, further comprising:
a control means for controlling the light source, the optical imaging means and the flat panel display;
a shape recognition means for acquiring the reflection of light projected from the light source toward the hand as a two-dimensional image to binarize the two-dimensional image by computation, thereby recognizing the shape of the hand; and
a display updating means for comparing the positions of the hand before and after a predetermined time interval to update the video picture on the flat panel display to a video picture corresponding to the motion of the hand, based on the motion of the hand.

4. The user interface display device according to claim 2, further comprising:
a control means for controlling the light source, the optical imaging means and the flat panel display;
a shape recognition means for acquiring the reflection of light projected from the light source toward the hand as a two-dimensional image to binarize the two-dimensional image by computation, thereby recognizing the shape of the hand; and
a display updating means for comparing the positions of the hand before and after a predetermined time interval to update the video picture on the flat panel display to a video picture corresponding to the motion of the hand, based on the motion of the hand.
